(19) United States
(12) Patent Application Publication
(10) Pub. No.: US 2010/0154374 A1
(43) Pub. Date: Jun. 24, 2010

(54) Lawn Mower and Droplet Wiping Roller Unit

(76) Inventors: Tadayuki Hibino, Suntougun (JP); Senichi Chiba, Gotenba-shi (JP)

Correspondence Address: WENDEROTH, LIND & PONACK, L.L.P., 1030 15th Street, N.W.,, Suite 400 East, Washington, DC, 20005-1503, US

(21) Appl. No.: 11/990,078

(22) PCT Filed: Aug. 8, 2006
(86) PCT No.: PCT/JP2006/315652

§ 371 Date: Feb. 6, 2008

(30) Foreign Application Priority Data
Aug. 11, 2005 (JP) 2005-233590
Dec. 1, 2005 (JP) 2005-348188

(51) Int. Cl. A01D 34/53; A01D 93/00

(52) U.S. Cl. 56/249; 56/1

(57) ABSTRACT

A lawn mower comprising a reel cutter type lawn mowing unit (A1) for neatly mowing a lawn by wiping droplets adhered to the lawn without damaging the lawn to increase the mowing rate of the lawn. A pair of right and left arms (21) are rotatably supported on the front part of the housing (12) of the lawn mowing unit (A1), and a roller (R1) for wiping droplets is rotatably supported at the free end parts of the pair of arms (21). Accordingly, the roller (R1) for wiping droplets is disposed at the front of the lawn mowing unit (A1) when used, and when not in use, allowed to retreat to a retreated position at the upper part of the lawn mowing unit (A1) positioned on the diagonal rear upper side of a use position.

### TECHNICAL FIELD

The present invention relates to a lawn mower which is able to mow a lawn neatly by wiping droplets staying on the lawn immediately before being mowed effectively when mowing the lawn in a golf course or the like and a droplet wiping roller unit.

### BACKGROUND ART

When mowing a lawn in a golf course or the like by a lawn mower having a reel cutter, if droplets such as dews or rain water are staying on the lawn, the lawn cannot be mowed sufficiently by the reel cutter because the lawn immediately before being mowed, which is trampled under a front roller, is lied down, or slippage occurs between the blade of the reel cutter and the lawn due to droplets getting into the lawn. Therefore, only about 50 to 70% of the case where it is dry can be mowed in comparison with. Consequently, there remain parts which are not mowed sufficiently, which impairs the appearance.

Therefore, wiping droplets staying on the lawn immediately before being mowed using a pole or a rope is conceivable. However, it requires an additional personnel and, in addition, since the droplet wiping job by itself is quite inefficient, the mowing work with high efficiency cannot be achieved. There is also proposed a method of wiping droplets staying on the lawn by blowing air to the lawn immediately before being mowed as disclosed in U.S. Pat. No. 5,873,223. However, since an apparatus for generating compressed air is inevitable, a large-scaled device which does not directly relate to the essential work, “mowing the lawn” is necessary, and hence the cost is increased. Furthermore, a method of providing a rotating brush in front of a reel-type lawn mowing unit is now in practical use. However, even though the droplets are removed by the brush, the lawn by itself (stem portions of the lawn remained after having mowed) may be damaged.

On the other hand, when the droplets are staying on clippings, the clippings are adhered to each other and are agglomerated. The appearance is not good if they remain untouched, and they cannot be collected smoothly in comparison with the case of collecting dry clippings dispersed over the lawn.

Accordingly, it is an object of the present invention to remove droplets staying on a lawn immediately before being mowed without damaging the lawn to increase the mowing rate of the lawn and achieving a neatly mowed lawn.

### DISCLOSURE OF THE INVENTION

In order to achieve the above-described object, a first aspect of the invention is a lawn mower provided with a reel-cutter type lawn mowing unit, characterized in that a pair of left and right arms are rotatably supported on a front portion of a housing of the lawn mowing unit and a droplet wiping roller is rotatably supported at free ends of the pair of arms, so that the droplet wiping roller is disposed forwardly of the lawn mowing unit, and the droplet wiping roller is retractable to a retracted position above the lawn mowing unit, which is an obliquely upper rear position with respect to the position in use, when it is not in use.

A second aspect of the invention is a lawn mower having a grass collecting box mounted to a front portion of a reel-cutter type lawn mowing unit, characterized in that a pair of left and right arms are rotatably supported on a front portion of the grass collecting box and a droplet wiping roller is rotatably supported at free ends of the pair of arms, so that the droplet wiping roller is disposed forwardly of the grass collecting box, and the droplet wiping roller is retractable to a retracted position above the grass collecting box, which is obliquely upper rear position with respect to the position in use, when it is not in use.

According to the first and second aspects of the invention, only the members for supporting the pair of arms which rotatably support the droplet wiping roller at the free ends thereof are different, and the effects and advantages of the droplet wiping rollers are the same. According to the first and second aspects of the invention, when the droplet wiping roller having the smooth outer peripheral surface rotates on the lawn immediately before being mowed while the lawn mower is traveling, droplets staying on the lawn are transferred and adhered easily to the outer peripheral surface of the droplet wiping roller. When the amount of droplets adhered to the outer peripheral surface of the droplet wiping roller increases and hence droplets of a specific portion drop onto the ground surface by their own weight, droplets of other portions are dragged therein and drop onto the ground surface as well. Therefore, the droplets staying on the lawn immediately before being mowed are effectively wiped off to the ground surface after having been transferred and adhered to the droplet wiping roller once. Therefore, the lawn immediately after having wiped off the droplets is mowed by a reel cutter, and hence the mowing rate of the lawn is increased, so that a beautiful mowed state is achieved. There is a case in which the droplets staying on leaves of the lawn are integrated with the leaves of the lawn by the surface tension, and hence they cannot be wiped off directly. However, since the outer peripheral surface of the droplet wiping roller is smooth and the contact surface with respect to the droplets on the lawn is large, the droplets which are integral with the leaves of the lawn by the surface tension are apt to be transferred and adhered to the outer peripheral surface of the droplet wiping roller. When the lawn mowing work is carried out when it is dry, or when the lawnmower is transported to and from the golf course, the droplet wiping roller is not necessary or even be a hindrance, and hence the droplet wiping roller connected to the front portion of the housing of the lawn mowing unit or the front portion of the grass collecting box via the pair of left and right arms is retracted to the retracted position above the lawn mowing unit or the grass correcting box, which is the obliquely upper rear position with respect to the position in use.

A third aspect of the invention is characterized in that in the first and second aspects of the present invention, the droplet wiping roller is formed into a cylindrical shape, and a pair of left and right arm portions which constitute the pair of arms are connected integrally to each other via a connecting portion, and in that the connecting portion is inserted and loosely fitted to a hollow portion of the cylindrical droplet wiping roller.

According to the third aspect of the invention, the connecting portion of the arm is inserted and loosely fitted to the hollow portion of the cylindrical droplet wiping roller, and the droplet wiping roller is able to move with respect to the connecting portion in a range of the inner diameter of the hollow portion thereof. Therefore, even in a case in which the lawn surface is inclined along the lateral direction which is orthogonal to the direction of travel of the lawn mower, the droplet wiping roller is able to be rotated while following the inclination. Therefore, the droplet wiping roller is able to come into contact with the lawn in the same state as on the flat plane, so that the ratio of transfer and adhesion of the droplets staying on the lawn to the outer peripheral surface of the droplet wiping roller is not lowered. Therefore, even when the lawn surface is inclined along the lateral direction which is orthogonal to the direction of travel of the lawn mower, the rate of adherence of the droplets on the lawn with respect to the droplet wiping roller is not lowered.

A fourth aspect of the invention is characterized in that in the third aspect of the present invention, the droplet wiping roller includes a plurality of cylindrical rollers, and the respective rollers arranged in the fore-and-aft direction are connected via connectors inserted through or inserted into the respective hollow portions in a loosely fitted state.

According to the fourth aspect of the invention, since the droplet wiping roller includes the plurality of rollers, the droplets on the lawn which failed to be adhered to the roller on the front side have an opportunity to be adhered to the roller on the back side. Therefore, the rate of adherence of the droplets on the lawn with respect to the droplet wiping roller is increased, and hence the lawn can be mowed further neatly. In addition, the rollers arranged in the fore-and-aft direction are able to move freely with respect to the respective connecting portions of the arms and the connectors within the range of the inner diameter thereof, and hence a force of mutual constraint is alleviated. Therefore, even when the lawn surface is inclined in the direction of travel of the lawn mower, the roller on the back side is displaced freely with respect to the roller on the front side corresponding to the inclination, and hence the droplets on the lawn are effectively transferred and adhered to the rollers even on the inclined lawn surface.

A fifth aspect of the invention is characterized in that in the fourth aspect of the present invention the outer diameter of the roller on the back side is smaller than the outer diameter of the roller on the front side.

According to the fifth aspect of the invention, in the two rollers arranged in the front and back, the droplets of the lawn which are not adhered to the large-diameter roller on the front side have an opportunity to be adhered to the small-diameter roller on the rear side. Therefore, the rate of adherence of the droplets on the lawn with respect to the droplet wiping rollers is increased, and hence the lawn can be mowed further neatly.

A sixth aspect of the invention is characterized in that in the first or second aspect of the present invention, the droplet wiping roller includes a plurality of rollers disposed at a predetermined distance in the fore-and-aft direction, both end portions of the plurality of rollers are connected respectively to each other via the connecting plates, and the left and right connecting plates are connected to the pair of left and right arms which are rotatably connected to the lawn mowing unit or the grass collecting box.

According to the sixth aspect of the invention, even when the droplet wiping roller includes the plurality of rollers, inconvenience such that the plurality of rollers are suspended at lower end portions of the pair of left and right arms in series when the droplet wiping roller units are lifted up for turning the lawn mower is avoided. Consequently, when the droplet wiping roller unit is put down, the plurality of rollers may always be brought into a normal working posture.

A seventh aspect of the invention is characterized in that in the sixth aspect of the present invention, the arm is provided with stoppers for preventing free rotation of the right and left connecting plates that connects the plurality of rollers when the droplet wiping roller unit is lifted up for turning the lawn mower.

According to the seventh aspect of the invention, the plurality of rollers can reliably be brought into a normal working posture when the droplet wiping roller unit is put down.

A eighth aspect of the invention is a droplet wiping roller unit to be mounted to a reel-cutter type lawn mowing unit, characterized in that a pair of left and right arms are rotatably supported at a front portion of a housing of the lawn mowing unit and the droplet wiping roller is rotatably supported at free ends of the pair of arms, so that the droplet wiping roller is disposed forwardly of the lawn mowing unit, and in that the droplet wiping roller is retractable to a retracted position above the lawn mowing unit, which is an obliquely upper rear position with respect to the position in use, when it is not in use. A ninth aspect of the invention is a droplet wiping roller unit to be mounted to a grass collecting box, which is mounted to a front portion of a reel-cutter type lawn mowing unit, characterized in that a pair of left and right arms are rotatably supported on a front portion of the grass collecting box, and the droplet wiping roller is rotatably supported at free ends of the pair of arms, so that the droplet wiping roller is disposed forwardly of the grass collecting box, and in that the droplet wiping roller is retractable to a retracted position above the grass collecting box, which is an obliquely upper rear position with respect to the position in use, when it is not in use.

The eighth aspect of the invention and the ninth aspect of the invention are described by viewing the first aspect of the invention and the second aspect of the invention, respectively, from a view point of the “droplet wiping roller unit”. The droplet wiping roller unit according to the eighth aspect of the invention can be mounted to the lawn mowing unit of the existing lawn mower, and the droplet wiping roller unit according to the ninth aspect of the invention is mountable to the grass collecting box mounted to the front portion of the existing lawn mowing unit, and other effects and advantages are substantially the same as the invention according to the first and second aspects of the invention.

### BRIEF DESCRIPTION OF THE DRAWINGS

FIG. 1 is a side view of a walk-along lawn mower having a droplet wiping roller unit U₁ mounted to a front portion of a lawn mowing unit A₁.

FIG. 2 is a plan view showing a portion of the same droplet wiping roller unit U₁.

FIG. 3 is a drawing showing operation to allow droplets W on a lawn G to be transferred and adhered to a droplet wiping roller R₁.

FIG. 4 is a partial side view of a lawn mower having a droplet wiping roller unit U₂ mounted to a front portion of a grass collecting box B₁ mounted to a front portion of the lawn mowing unit A₁.

FIG. 5 is a schematic side view of a lawn mower having a droplet wiping roller unit U₃ mounted to a front portion of a grass collecting box B₂ mounted to a front of a lawn mowing unit A₂.

FIG. 6 is a partial perspective view of the droplet wiping roller unit U₃.

FIG. 7 is a plan view of the droplet wiping roller unit U₃ partly broken.

FIG. 8 is a schematic side view of a lawn mower having a droplet wiping roller unit U₄ according to Example 4 mounted to a front portion of a grass collecting box B₃.

FIG. 9 is a schematic plan view of the same, partly broken.

FIGS. 10 (A) and (B) are partial perspective views of the droplet wiping roller unit U₄ in use and in a state of being lifted up, respectively.

FIG. 11 is a partial side view showing a posture of two droplet wiping rollers R₄ in a state in which the grass collecting box B₃ about a drive wheel 1 is lifted.

FIG. 12 is a side view of a droplet wiping roller unit U₅ including a droplet wiping roller R₅ having two droplet wiping rollers R₅₁, R₅₂ having different outer diameters and being connected by a pair of left and right connecting plates 41′.

### BEST MODES FOR CARRYING OUT THE INVENTION

The present invention will be described further in detail while referring to a plurality of best modes for carrying out the invention.

### Example 1

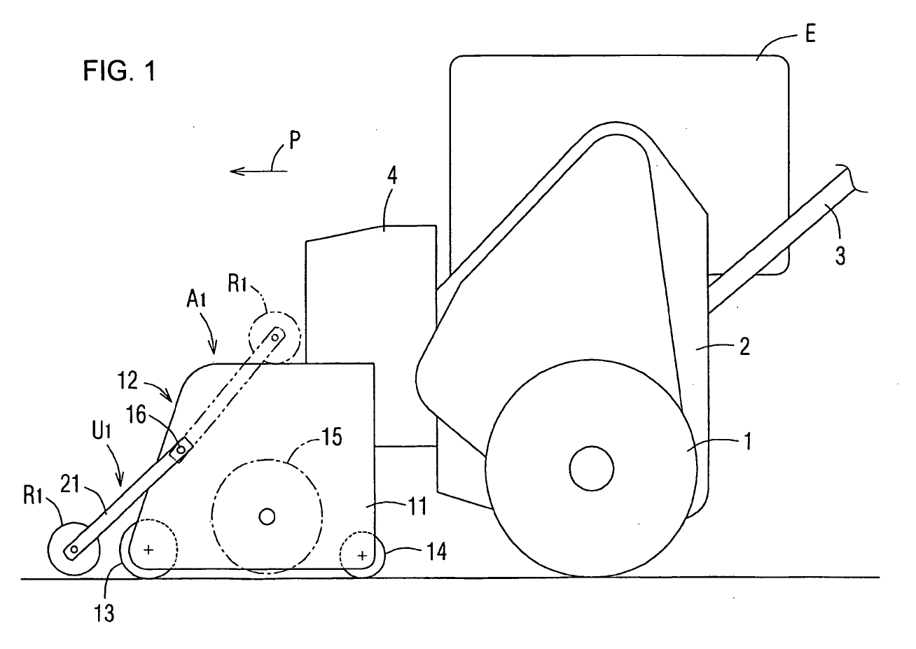

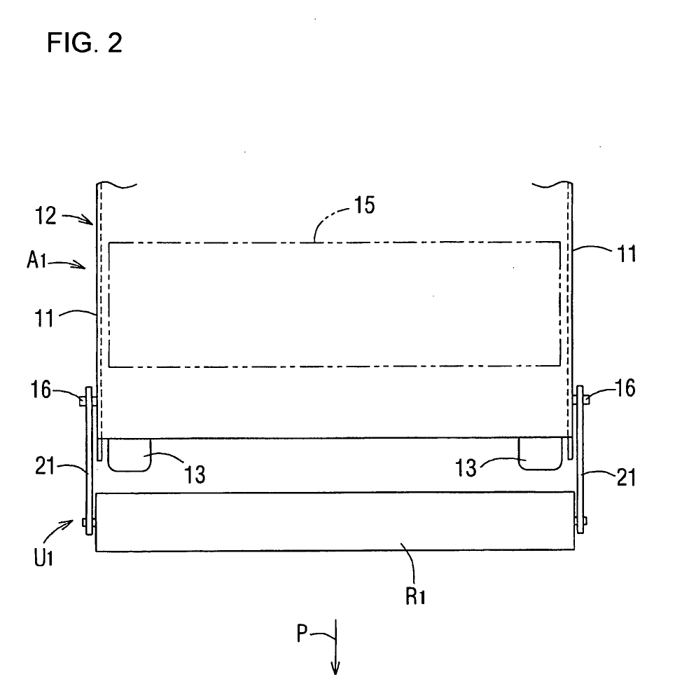

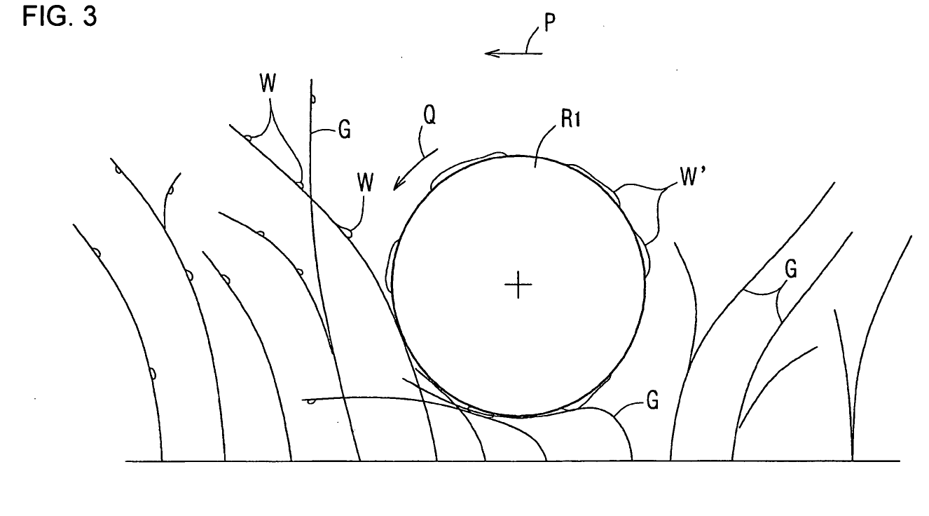

FIG. 1 is a side view of a walk-along lawn mower having a droplet wiping roller unit U₁ mounted to a front portion of a lawn mowing unit A₁; FIG. 2 is a plan view showing a portion of the same droplet wiping roller unit U₁; and FIG. 3 is a drawing showing operation to allow droplets W on a lawn G to be transferred and adhered to a droplet wiping roller R₁. In FIG. 1 and FIG. 2, the lawn mowing unit A₁ is mounted to a front portion of a machine body 2 provided with a drive wheel 1. The lawn mowing unit A₁ includes a housing 12 having side panels 11, a front roller 13 and a rear roller 14 mounted to front and rear ends of the housing 12 and a reel cutter 15 to be supported by the side panels 11 and rotated by a power of an engine E mounted to the machine body 2, and travels integrally with the machine body 2. In FIG. 1, reference numeral 3 designates a handle of the lawn mower, and reference numeral 4 designates a connector for connecting the machine body 2 and the lawn mowing unit A₁.

The droplet wiping roller unit U₁ is mounted to the front portion of the lawn mowing unit A₁, and the droplet wiping roller unit U₁ includes the droplet wiping roller R₁ and a pair of arms 21 for connecting the droplet wiping roller R₁ to the housing 12 of the lawn mowing unit A₁. In other words, upper end portions of the pair of arms 21 are rotatably supported by the side panels 11 of the housing 12 of the lawn mowing unit A₁ via a rocking pin 16, and the droplet wiping roller R₁ is configured to move upward and downward with respect to the housing 12 of the lawn mowing unit A₁ in accordance with the height of the lawn G or slight ups and downs of the lawn surface. On the other hand, when the lawn is in a dry state, or when the lawn mower is transported, the droplet wiping roller R₁ supported by the side panels 11 of the housing 12 of the lawn mowing unit A₁ via the pair of arms 21 is retracted to obliquely upper rear position as indicated by a chain double-dashed line in FIG. 1, so that the lawn mowing work in the dry state or transportation of the lawn mower can be carried out without being hindered by the droplet wiping roller R₁. The outer peripheral surface of the droplet wiping roller R₁ is smooth (grooves or the like are not formed at all).

Therefore, when the droplet wiping roller R₁ having the smooth outer peripheral surface rotates on the lawn G immediately before being mowed while the lawn mower is traveling, the droplets W staying on the lawn G are transferred and adhered easily to the outer peripheral surface of the droplet wiping roller R₁. When the amount of droplets W′ adhered to the outer peripheral surface of the droplet wiping roller R₁ increases and hence droplets of a specific portion drop onto the ground surface by their own weight, droplets of other portions are dragged therein and drop onto the ground surface as well. Therefore, the droplets staying on the lawn G immediately before being mowed are effectively wiped off to the ground surface after having been transferred and adhered to the droplet wiping roller R₁ once. Therefore, the lawn G immediately after having wiped off the droplets W is mowed by the reel cutter 15, and hence the mowing rate of the lawn G is increased, so that the beautiful mowed state is achieved. There is a case in which the droplets W staying on leaves of the lawn G are integrated with the leaves of the lawn G by the surface tension, and hence they cannot be wiped off directly. However, since the outer peripheral surface of the droplet wiping roller R₁ is smooth and the contact surface with respect to the droplets W on the lawn G is large, the droplets W which are integrated with the leaves of the lawn G by the surface tension are apt to be transferred and adhered to the outer peripheral surface of the droplet wiping roller R₁.

In this manner, when the droplets W staying on the lawn G immediately before being mowed are transferred and adhered to the droplet wiping roller R₁ while the lawn mower is traveling and the amount of adherence is increased, the droplets W′ transferred and adhered to the droplet wiping roller R₁ drop onto the ground surface, and then the lawn G having wiped off the droplets W is mowed by the reel cutter 15. In other words, the invention is characterized in that the work to wipe off the droplets W from the lawn G can be carried out simultaneously with mowing of the lawn G by the lawn mower without carrying out separately. Since the outer peripheral surface of the droplet wiping roller R₁ is smooth, even though it is rotated on the lawn G, the lawn G is not damaged. In FIG. 1 to FIG. 3, reference sign P designates the direction of travel of the lawn mower and reference sign Q designates the direction of rotation of the droplet wiping roller R₁.

### Example 2

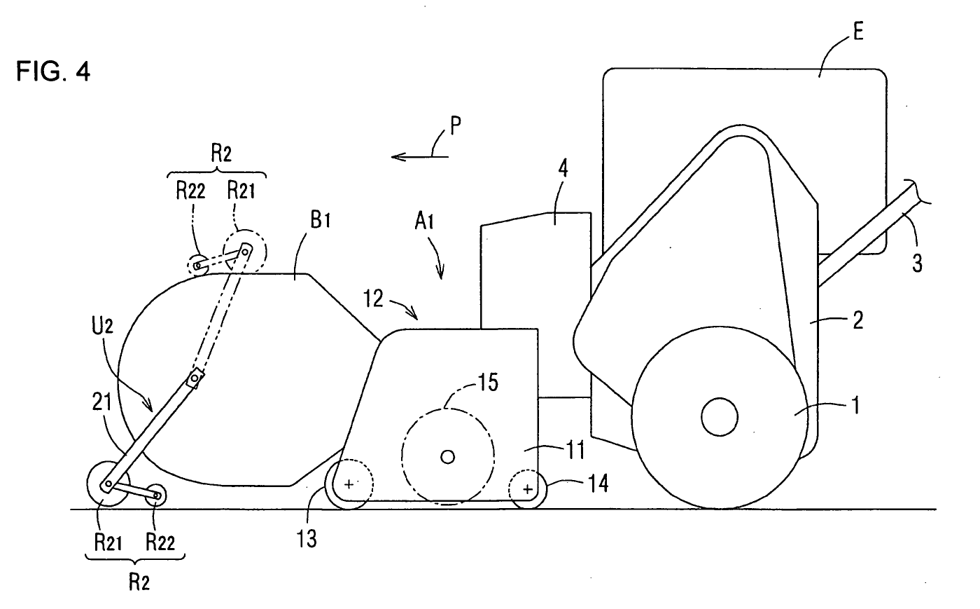

FIG. 4 is a partial side view of a lawn mower having a droplet wiping roller unit U₂ mounted to a front portion of a grass collecting box B₁, which is mounted to a front portion of the lawn mowing unit A₁. There may be a case in which the grass collecting box B₁ for collecting the clippings is mounted on the front portion of the lawn mowing unit A₁. In this case, the droplet wiping roller unit U₂ is disposed on the front portion of the grass collecting box B₁. A droplet wiping roller R₂ which constitutes the droplet wiping roller unit U₂ in Example 2 includes a large-diameter roller R₂₁ arranged on the front side and a small-diameter roller R₂₂ arranged on the rear side. In Example 2, since the droplet wiping roller R₂ is composed of the two rollers R₂₁, R₂₂ having the different outer diameters, the droplets W of the lawn G which are not adhered to the large-diameter roller R₂₁ on the front side have another opportunity to be adhered to the small-diameter roller R₂₂ on the rear side. Therefore, the rate of adherence of the droplets of the lawn to the droplet wiping roller R₂ is increased, and hence the lawn can be mowed further neatly.

### Example 3

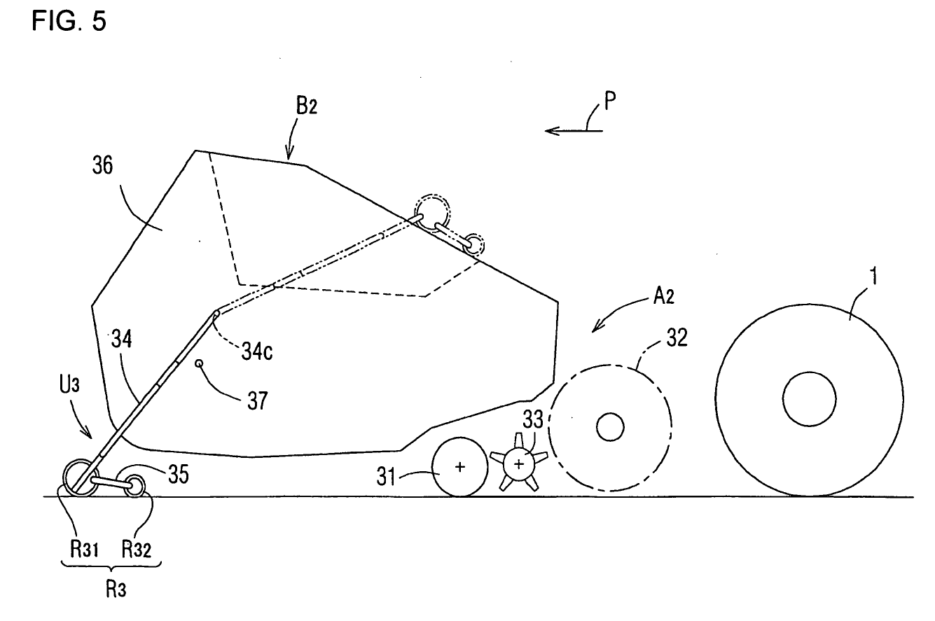

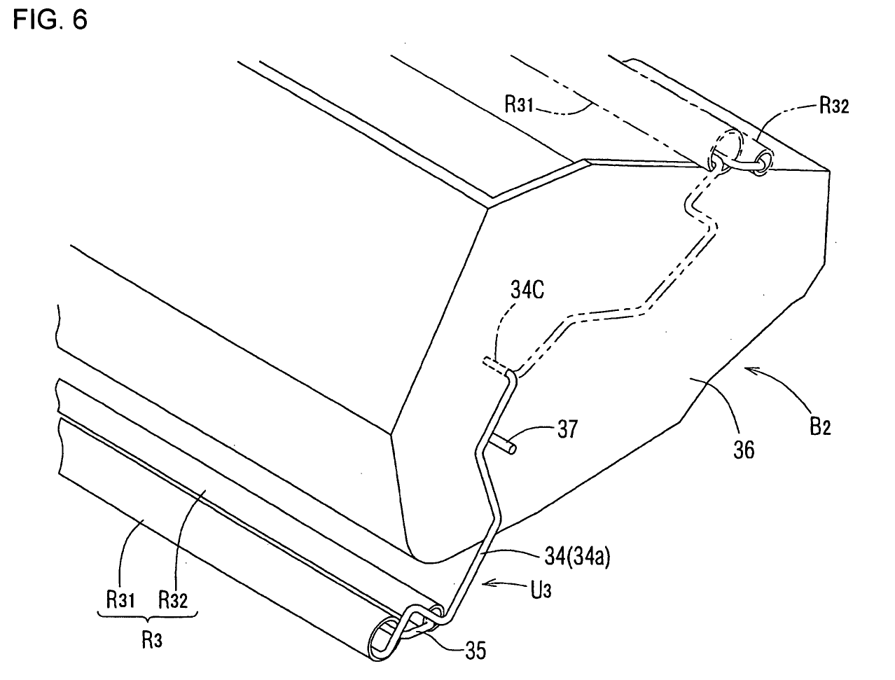

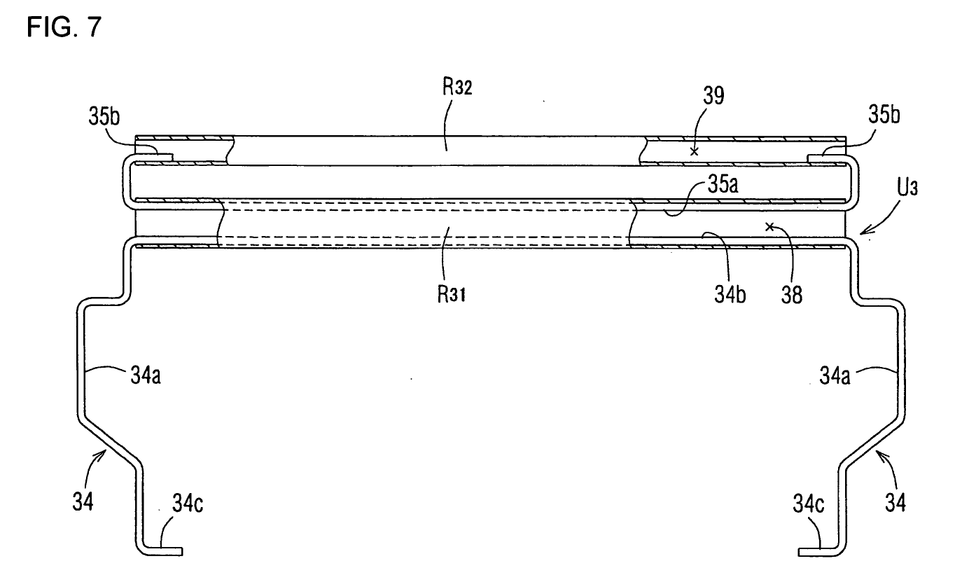

FIG. 5 is a schematic side view of a lawn mower having a droplet wiping roller unit U₃ mounted to a front portion of a grass collecting box B₂ mounted to a front of a lawn mowing unit A₂; FIG. 6 is a partial perspective view of the droplet wiping roller unit U₃, and FIG. 7 is a plan view of the droplet wiping roller unit U₃ partly broken. The lawn mowing unit A₂ includes a reel cutter 32 disposed between the drive wheel 1 and a front roller 31, and a thatching roller 33 that scoops parts of the lawn grasses getting under the lawn for facilitating mowing by the reel cutter 32 on the rear side disposed in front of the reel cutter 32. The droplet wiping roller unit U₃ includes a droplet wiping roller R₃ including a large-diameter roller R₃₁ formed into a cylindrical shape with resin and a small-diameter roller R₃₂ formed into the same shape with the same material, an arm 34 for connecting the large-diameter roller R₃₁ to both side panel portions 36 of the grass collecting box B₂, and a connector 35 for connecting the small-diameter roller R₃₂, which is arranged on the back side of the large-diameter roller R₃₁, to the large-diameter roller R₃₁. The arm 34 is formed into a substantially angular C-shape in plan view, and includes arm portions 34a at both ends and a linear connecting portion 34b for connecting the respective arm portions 34a connected integrally with respect to each other, and the connecting portion 34b is inserted and loosely fitted into a hollow portion 38 of the large-diameter roller R₃₁. The arm portion 34a at both ends are bent and proximal ends of the respective arm portions 34a are bent inwardly at a right angle to serve as a supporting point of rotation 34c. Therefore, the large-diameter roller R₃₁ is connected to the both side panel portions 36 of the grass collecting box B₂ via the arm 34. The connector 35 is bent into an angular C-shape by being bent at both end portions of a linear body portion 35a inwardly to form connecting portions 35b, and the body portion 35a is inserted and loosely fitted into the large-diameter roller R₃₁, and the respective connecting portions 35b at both ends are inserted and loosely fitted to a hollow portion 39 of the small-diameter roller R₃₂. In FIG. 5 and FIG. 6, reference numeral 37 designates a stopper pin provided on the side panel portions 36 of the grass collecting box B₂ for restraining the rotation of the arm 34 toward the reel cutter 32 when the lawn mowing unit A₂ is lifted for being turned.

In this manner, since the connecting portion 34b of the arm 34 is inserted and loosely fitted to the hollow portion 38 of the large-diameter roller R₃₁ which constitutes the droplet wiping roller R₃, the large-diameter roller R₃₁ is able to move freely with respect to the connecting portion 34b of the arm 34 in the range of its inner diameter. Likewise, the small-diameter roller R₃₂ is able to move freely with respect to the connecting portions 35b of the connector 35 in the range of its inner diameter. Therefore, during the lawn mowing work, the large-diameter and small-diameter rollers R₃₁, R₃₂ are respectively able to be inclined while following the inclination of the lawn surface in the lateral direction (the direction orthogonal to the direction of travel), and the small-diameter roller R₃₂ on the back side is able to follow easily to the inclination of the lawn surface in the direction of travel (fore-and-aft direction). Therefore, even when the lawn surface is inclined, the large-diameter and small-diameter rollers R₃₁, R₃₂ are respectively able to come into contact with the lawn G immediately before being mowed over the entire lengths thereof in the same state as on the flat plane, so that the droplets W staying on the lawn G are advantageously transferred and adhered thereto easily. When the water droplet wiping roller unit U₃ is not in use, the droplet wiping roller R₃ is rotated and retracted from the position in use to a position above the grass collecting box B₂ about the supporting point of rotation 34c of the arm 34, similarly to the Examples 1 and 2.

### Example 4

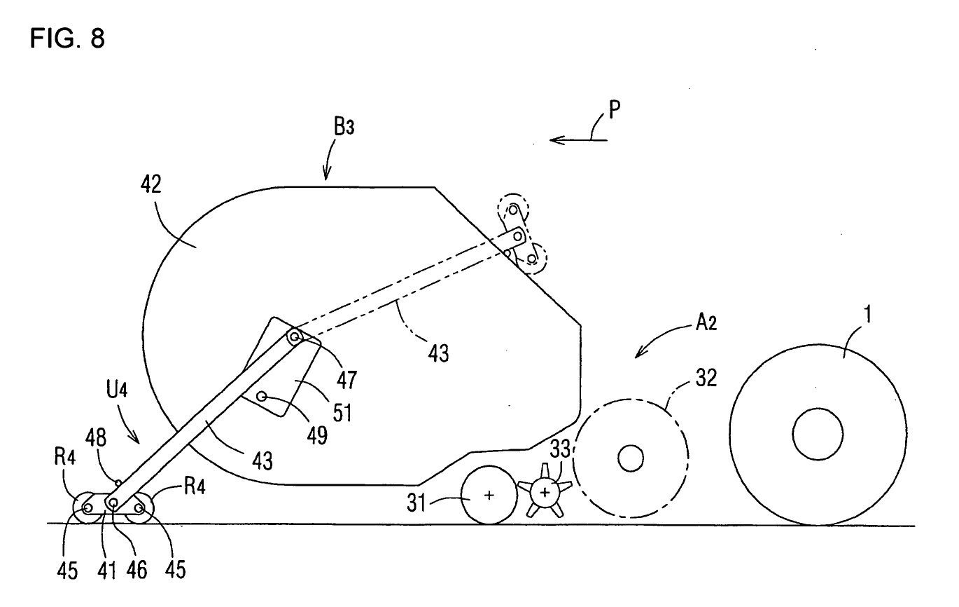

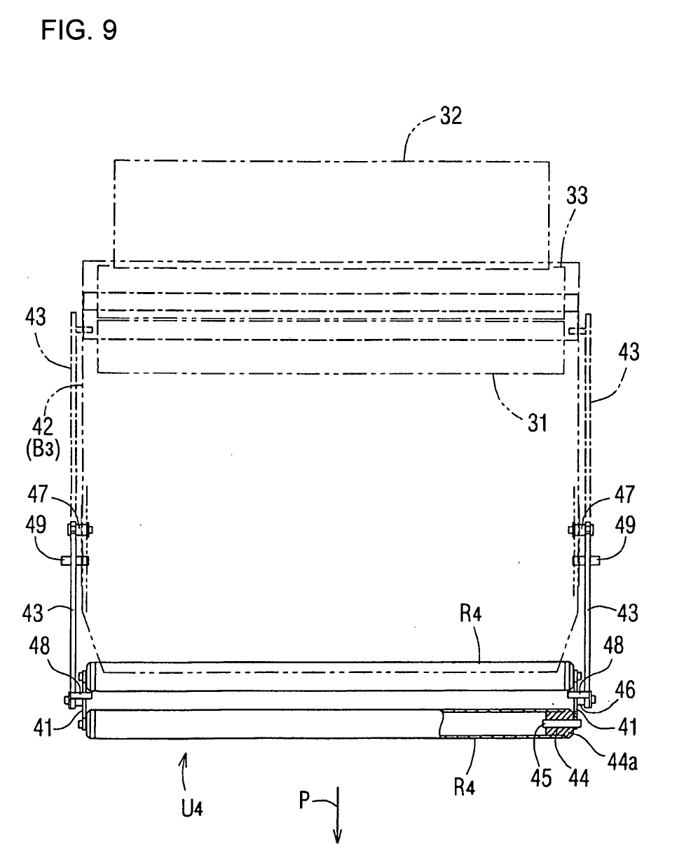

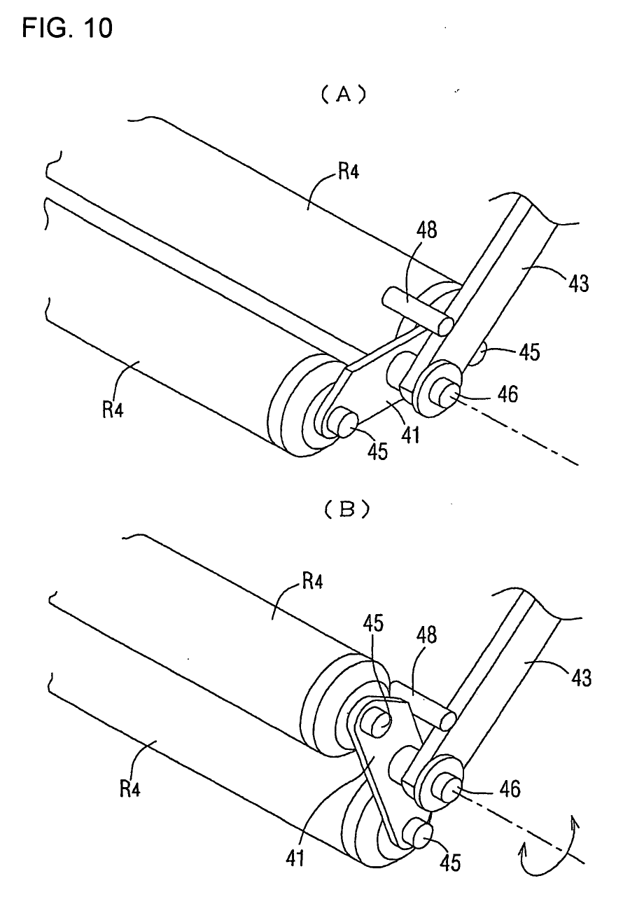

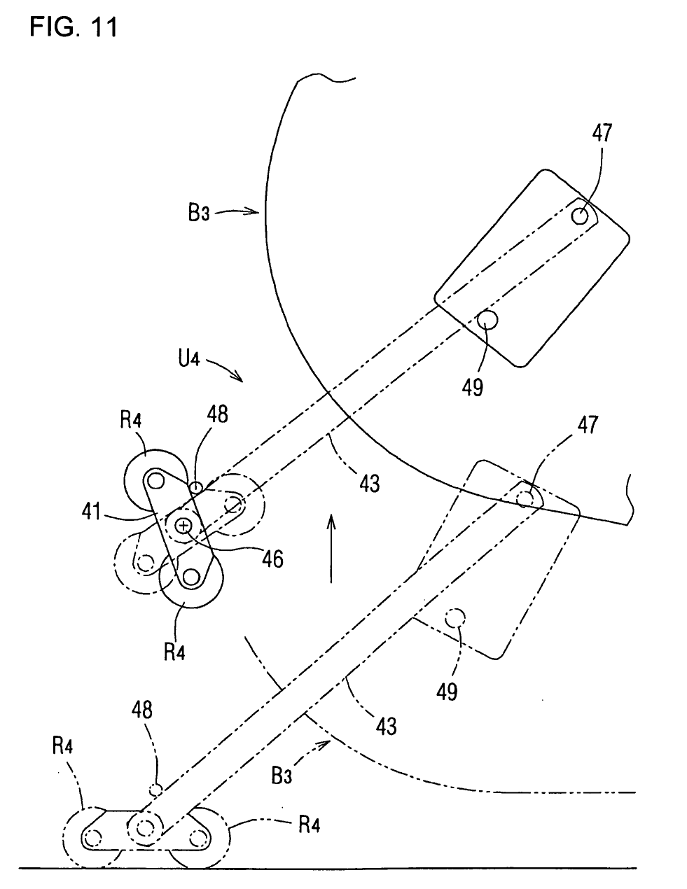

FIG. 8 is a schematic side view of a lawn mower having a droplet wiping roller unit U₄ according to Example 4 mounted to a front portion of a grass collecting box B₃; FIG. 9 is a schematic plan view of the same, partly broken; and FIGS. 10 (A) and (B) are partial perspective views of the droplet wiping roller unit U₄ in use and in a state of being lifted up, respectively. The droplet wiping roller unit U₄ includes two droplet wiping rollers R₄ connected by a connecting plates 41 at both ends at a predetermined distance along the direction P of travel of the lawnmower and a pair of left and right arms 43 for connecting the two droplet wiping rollers R₄, which are connected by the connecting plates 41, to side panel portions 42 of the grass collecting box B₃. The two droplet wiping rollers R₄ are formed of resin into a cylindrical shape, and each have fitting members 44 having flanges 44a at both ends thereof. The two droplet wiping rollers R₄ arranged at the predetermined distance along the direction P of travel of the lawnmower are rotatably supported with respect to supporting shafts 45, which are fixed respectively to the pair of left and right connecting plates 41. In other words, the supporting shafts 45 are in a state of being inserted through center portions of the fitting members 44 with slight clearances remained. The pair of left and right connecting plates 41 are provided integrally with arm supporting pins 46 at the centers in the fore-and-aft direction on the outer sides thereof. Proximal ends and distal ends of the arms 43 are connected respectively to rocking pins 47 provided on the side panel portions 42 of the grass collecting box B₃ and arm supporting pins 46 provided on the connecting plates 41 respectively. Therefore, as indicated by a chain double-dashed line in FIG. 8, the two droplet wiping rollers R₄ connected by the pair of connecting plates 41 are retracted from the position in use by being rotated to obliquely upper rear positions with respect to the grass collecting box B₃ about the rocking pins 47 when not in use. As shown in FIG. 11, when the lawn mower is turned, the grass collecting box B₃ is lifted about the drive wheel 1, so that the two droplet wiping rollers R₄ are brought into a state of being suspended from the distal ends of the pair of arms 43. Therefore, the arms 43 are provided at the distal ends thereof with stopper pins 48 for preventing the two droplet wiping rollers R₄ integrated with each other by the pair of connecting plates 41 from freely rotating reversely in this state. In FIG. 8 and FIG. 9, reference numerals 49 designate stopper pins for limiting the position of the arm 43 with respect to the grass collecting box B₃ when the grass collecting box B₃ is lifted about the drive wheel 1, and reference numerals 51 designate metallic plates integrally formed on the side panel portions 42 for enhancing the strength of the portions of the side panel portions 42 of the resin grass collecting box B₃ where the rocking pins 47 and the stopper pins 49 are provided.

Therefore, according to the droplet wiping roller unit U₄ in Example 4, the droplets W staying on the lawn G are transferred and adhered to the two droplet wiping rollers R₄ provided in the front and back, there are two opportunities of transferring and adhering, so that the rate of wiping of the droplets W staying on the lawn G is increased. When the lawn mower is turned, even in the case in which the grass collecting box B₃ is lifted about the drive wheel 1, the two droplet wiping rollers R₄ connected by the pair of left and right connecting plates 41 are prevented from being suspended significantly so that the lawn G is prevented from becoming damaged when the droplet wiping roller unit U₄ is put down after the lawn mower has turned. Simultaneously, reverse rotation of the two droplet wiping rollers R₄ connected by the pair of left and right connecting plates 41 is also prevented so that a smooth mowing work is achieved.

### Example 5

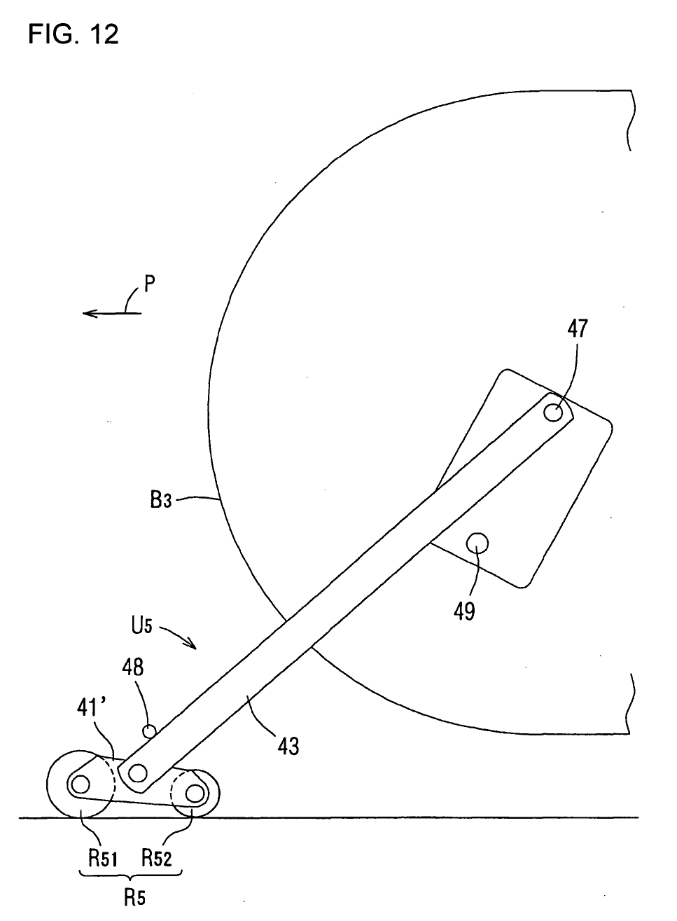

FIG. 12 is a side view of a droplet wiping roller unit U₅ including a droplet wiping roller R₅ having two droplet wiping rollers R₅₁, R₅₂ having different outer diameters and being connected by the pair of left and right connecting plates 41′. Since the diameters of the two droplet wiping rollers R₅₁, R₅₂ which constitute the droplet wiping roller R₅ are different from each other, the same effects and advantages as Example 2 are obtained.

In Examples 2 to 5, the two droplet wiping rollers are arranged at the front and back. However, it is also possible to arrange three or more droplet wiping rollers in fore-and-aft direction.

Examples 1 to 5 are examples in which the invention is applied to the walk-along lawn mower having the reel-cutter type lawn mowing unit. However, the invention is also applicable to a riding type lawnmower provided with a plurality of series of mowing units in the same manner.

1-9. (canceled)

10. A lawn mower provided with a reel-cutter type lawn mowing unit, wherein a pair of left and right arms are rotatably supported on a front portion of a housing of the lawn mowing unit and a droplet wiping roller is rotatably supported at free ends of the pair of arms so that the droplet wiping roller is disposed forwardly of the lawn mowing unit, and the droplet wiping roller is retractable to a retracted position above the lawn mowing unit, which is an obliquely upper rear position with respect to the position in use, when it is not in use.

11. A lawn mower having a grass collecting box mounted to a front portion of a reel-cutter type lawn mowing unit, wherein a pair of left and right arms are rotatably supported on a front portion of the grass collecting box and a droplet wiping roller is rotatably supported at free ends of the pair of arms, so that the droplet wiping roller is disposed forwardly of the grass collecting box, and the droplet wiping roller is retractable to a retracted position above the grass collecting box, which is obliquely upper rear position with respect to the position in use, when it is not in use.

12. The lawn mower according to claim 10, wherein the droplet wiping roller is formed into a cylindrical shape, and a pair of left and right arm portions which constitute the pair of arms are connected integrally to each other via a connecting portion, and in that the connecting portion is inserted and loosely fitted to a hollow portion of the cylindrical droplet wiping roller.

13. The lawn mower according to claim 12, wherein the droplet wiping roller includes a plurality of cylindrical rollers, and the respective rollers arranged in the fore-and-aft direction are connected via connectors inserted through or inserted into the respective hollow portions in a loosely fitted state.

14. The lawn mower according to claim 13, wherein the outer diameter of the roller on the back side is smaller than the outer diameter of the roller on the front side.

15. The lawn mower according to claim 10, wherein the droplet wiping roller includes a plurality of rollers disposed at a predetermined distance in the fore-and-aft direction, both end portions of the plurality of rollers are respectively connected to each other via connecting plates, and the left and right connecting plates are connected to the pair of left and right arms rotatably connected to the lawn mowing unit or the grass collecting box.

16. The lawn mower according to claim 15, wherein the arm is provided with stoppers for preventing free rotation of the plurality of rollers connected by the light and left connecting plates when the droplet wiping roller unit is lifted up for turning the lawn mower.

17. A droplet wiping roller unit to be mounted to a reel-cutter type lawn mowing unit, wherein a pair of left and right arms are rotatably supported at a front portion of a housing of the lawn mowing unit and the droplet wiping roller is rotatably supported at free ends of the pair of arms, so that the droplet wiping roller is disposed forwardly of the lawn mowing unit, and the droplet wiping roller is retractable to a retracted position above the lawn mowing unit, which is an obliquely upper rear position with respect to the position in use, when it is not in use.

18. A droplet wiping roller unit to be mounted to a grass collecting box, which is mounted to the front portion of a reel-cutter type lawn mowing unit, wherein a pair of left and right arms are rotatably supported on the front portion of the grass collecting box, and the droplet wiping roller is rotatably supported at free ends of the pair of arms, so that the droplet wiping roller is disposed forwardly of the grass collecting box, and the droplet wiping roller is retractable to a retracted position above the grass collecting box, which is an obliquely upper rear position with respect to the position in use, when it is not in use.

19. The lawn mower according to claim 11, wherein the droplet wiping roller includes a plurality of cylindrical rollers, and the respective rollers arranged in the fore-and-aft direction are connected via connectors inserted through or inserted into the respective hollow portions in a loosely fitted state.

20. The lawn mower according to claim 11, wherein the droplet wiping roller includes a plurality of rollers disposed at a predetermined distance in the fore-and-aft direction, both end portions of the plurality of rollers are respectively connected to each other via connecting plates, and the left and right connecting plates are connected to the pair of left and right arms rotatably connected to the lawn mowing unit or the grass collecting box.
